(19) United States
(12) Patent Application Publication
(10) Pub. No.: US 2004/0128482 A1
(43) Pub. Date: Jul. 1, 2004

(54) Eliminating register reads and writes in a scheduled instruction cache

(76) Inventor: Gad S. Sheaffer, Haifa (IL)

Correspondence Address: KENYON & KENYON (SAN JOSE), 333 WEST SAN CARLOS ST., SUITE 600, SAN JOSE, CA, 95110, US

(21) Appl. No.: 10/330,971

(22) Filed: Dec. 26, 2002

(51) Int. Cl. G06F 9/30

(52) U.S. Cl. 712/215; 712/218

(57) ABSTRACT

A method and apparatus for eliminating register reads and writes in a scheduled instruction cache. More particularly, the present invention pertains to a method of increasing overall processor performance by implementing a novel pre-cache scheduling operation to eliminate superfluous register reads and writes via a bypass network.

### BACKGROUND OF THE INVENTION

The present invention pertains to a method and apparatus for eliminating register reads and writes in a scheduled instruction cache. More particularly, the present invention pertains to a method of increasing overall processor performance by implementing a novel pre-cache scheduling operation to eliminate superfluous register reads and writes via a bypass network.

In a pipelined processor, in order to ensure that all instructions acquire the appropriate input value in the presence of all the parallel execution activities and data dependencies, various mechanisms are utilized. Two common architectural features for handling data dependencies in a pipelined processor design are the latch and the register bypass.

Latches utilize a mechanism known as pipeline interlocking. Interlocking imposes delays to instructions to ensure that they acquire the appropriate input operand values when they are available. These delays are generally handled by introducing NOPs (also “no-op” instructions, or no operation instructions) into the execution path.

A bypass is used when an interlocked instruction obtains a result from an earlier source instead of waiting for the instruction that writes the result to complete. Otherwise, the interlocked instruction would stall for several clock cycles, awaiting the completion of the register accesses (i.e. a register write or read or both) before receiving the data needed. For example, a common bypass may occur from an execution unit, such as an ALU (Arithmetic Logic Unit). The instruction will have a source operand that is the result of a mathematical operation of another instruction. If the instruction that needs the result (the “consumer”) is executed before or at the same time as the instruction that produces the result (the “producer”), the consumer will interlock until a result becomes available. By utilizing a bypass from the output of the ALU, the consumer can receive the result directly from the execution unit. Without the use of this bypass, the consumer would stay interlocked for several cycles waiting for the producer to write the result to the register before being able to access the register to read the result.

Current processors use bypasses to shorten the latency between producers and consumers. However, when the data is taken and forwarded to consumers, the data values are still placed in the register file, without knowing whether any potential consumers need the data further down the instruction set. Although a dependency analysis is performed to enable the bypass, systems currently implemented cannot determine if another consumer for the data exists. In general, a demand exists to speed up and eliminate unnecessary operations, thereby increasing overall system performance.

Also, when these present-day systems utilize a bypass, a CAM (content addressable memory) match is performed. For each data item that can be bypassed, the logical registers, which are referenced within instruction fields, are compared to the register names being broadcast on the bypass network. The CAM match performs an associative match, one in which every consumer is trying to compare its operand against every producer placing data values in the bypass network from the previous cycle. This creates latencies which compromise system performance. By utilizing a more efficient bypass network, preferably without a global network of CAM matches, system performance can be enhanced.

In view of the above, there is a need for a method and apparatus for eliminating register reads and writes in a scheduled instruction cache.

### BRIEF DESCRIPTION OF THE DRAWINGS

FIG. 1 is a block diagram of a portion of a processor system employing an embodiment of the present invention.

FIG. 2 is a flow diagram showing an embodiment of a method according to an embodiment of the present invention.

### DETAILED DESCRIPTION OF THE DRAWINGS

In a fully scheduled instruction cache, a reduction in the number of register accesses (i.e. register reads and writes) may be achieved. A general example follows. Assume that instruction A produces a value and stores it in a register. Assume that instruction B, and only instruction B consumes that value by reading that register. If instruction B is scheduled in the cycle at which instruction A produces that value, and into an execution pipeline in which a bypass exists from the execution pipeline in which instruction A produced the result, the bypass is all that is needed to transfer the result of A to B. The register read and write operations would be superfluous in this case. The elimination of register accesses can save the processor system a potentially large percentage of register reads and writes accesses, as a high as 40% in certain cases.

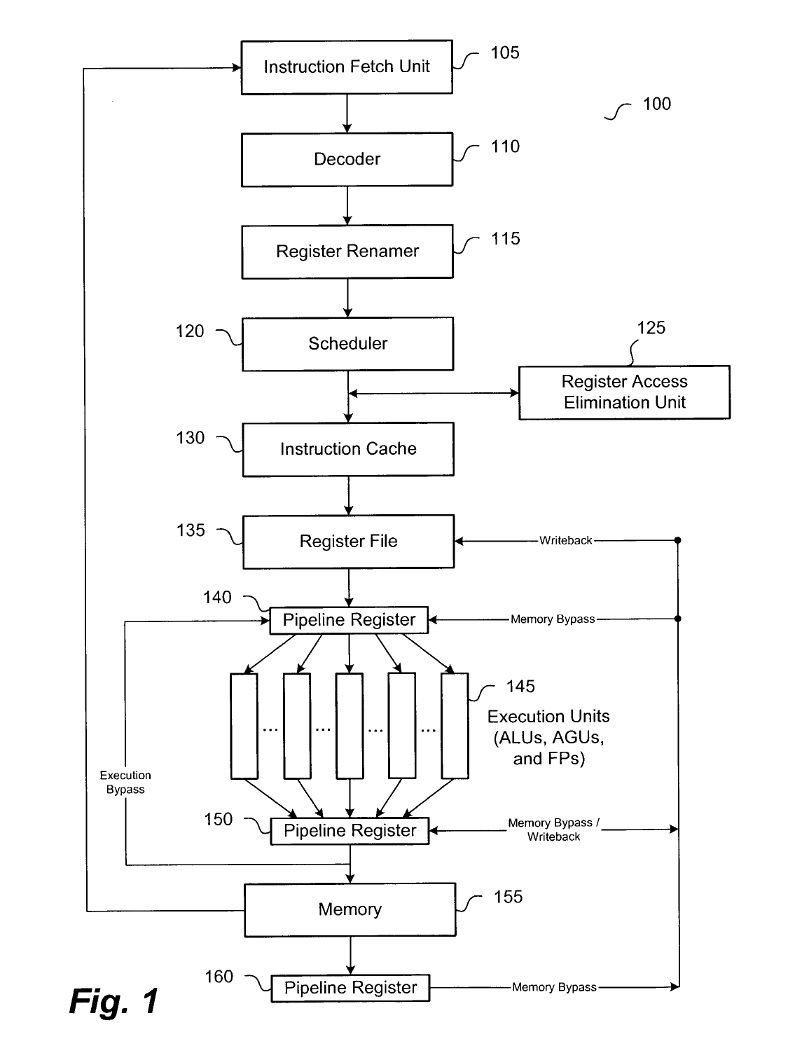

Referring to FIG. 1, a block diagram of a portion of a processor system 100 (e.g. a microprocessor, a digital signal processor, or the like) employing an embodiment of the present invention is shown. In this embodiment of the processor system 100, instructions are fetched by fetch unit 105 from memory 155 (e.g. from system memory or cache memory). Instructions are then forwarded to decoder 110 to decode the opcode and determine the type of instruction to be executed. Register renamer 115 then receives the instructions to map the architectural registers to the physical registers. Scheduler 120 then receives the instructions from register renamer 115 and proceeds to group and schedule the instruction sets for block retirement. In block retirement mode, instructions are grouped in execution blocks, and scheduled for execution in a group of consecutive VLIW (Very Long Instruction Word) strings. Register access elimination (hereafter, “RAE”) unit 125 then performs a dependency analysis on the instruction blocks. RAE unit 125 determines which instructions can use a bypass, and from those, which register accesses can be eliminated. By block retiring these instructions and implementing an embodiment of this method to analyze the instruction code, all known producers and consumers can be identified for a particular register.

The mechanics of scheduling VLIW instructions in block retirement mode can be demonstrated in a simplified example. Detection of these cases is dependent on the pre-cache scheduling operation, which looks at the block of instructions to see if any destination registers match a source register reference for atomic retirement. Employing an embodiment of the present invention in this example, RAE unit 125 analyzes a block of instructions that includes a first producer and a second producer of register 1000, including first and second consumers in between that need the data from the first producer of register 1000. As such, the data result from the first producer can be transferred over bypasses to the first and second consumer. Therefore, the register write to register 1000 can be eliminated, and likewise, the reads by the first and second consumer are also eliminated. In regards to any future consumers forward in the instruction stream that might have needed the value of the first producer (e.g. an exception handler), the first producer should be fetched again for execution. Accessing register 1000 for the necessary data would be in error, as the second producer would have placed a new value in register 1000. RAE unit 125 analyzes the pre-cache scheduled VLIW instruction code in block retirement mode. Specifically, RAE unit 125 determines the relative cycles in which the producer and consumers of any given register are scheduled, and thereby, has the ability to determine whether data can be bypassed directly from the producer to all the consumers, and as a result, eliminate their corresponding register accesses. One skilled in the art will appreciate that RAE unit 125 may be incorporated into the scheduler 120 either as a unit within the scheduler 120 or as a single-unit scheduler capable of the same analysis as RAE unit 125.

After instruction analysis by RAE unit 125, instructions are stored in instruction cache 130 and forwarded for execution. Register file 135 is accessed when source operands are fetched. The instructions access the register file information, and next, are forwarded to execution units 145, including, but not limited to, ALUs, AGUs (Address Generator Units), and FPUs (Floating Point Units). When bypasses are available, as determined by RAE unit 125, the data values are transferred via the bypass network, including but not limited to, multiple pipeline registers 140, 150 and 160. Pipeline registers 140, 150, and 160 are located within the execution pipeline to enable the bypasses and forward the data when dependences exist. In general, one skilled in the art will appreciate that the pipeline registers 140, 150 and 160 may be designed with multiple circuits for enabling the bypass as well as generating NOPs to interlock the pipeline to resolve the bypass timing. If a bypass cannot be utilized, as determined by RAE unit 125, the producers instructions write into the register file for the consumer instructions to read from. After execution operations are performed, memory 155 contents and register file 135 are updated at writeback for future register accesses. Thus, when the bypass network is utilized as a result of pre-cache scheduling and block retirement, superfluous register reads and writes can be eliminated. Removal of these unnecessary operations saves processor cycles and reduces power consumption by the processor, and in turn, increases overall system performance.

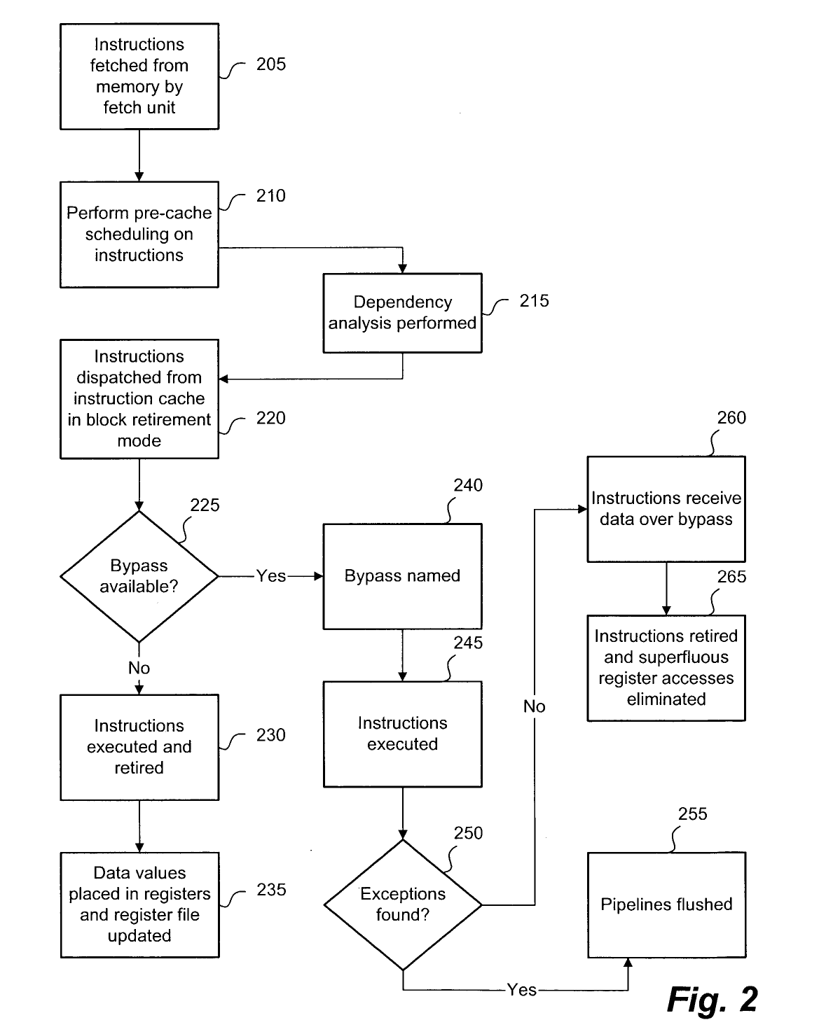

Referring to FIG. 2, a flow diagram of an embodiment of a method according to an embodiment of the present invention is shown. An example of the bypass operation by processor system 100 in this embodiment is shown in FIG. 2. In block 205, instruction fetch unit 105 dispatches for instructions from memory. Instructions proceed down the processor pipeline and, in block 210, a pre-cache scheduling operation is performed on the instructions. The VLIW instruction blocks proceed to block 215, where a dependency analysis is completed. In block 215, RAE unit 125 determines which instructions can use a bypass and which register accesses can be eliminated from those bypasses. Part of the dependency analysis performed by RAE unit 125 includes determining if bypass can be made available to satisfy all consumers for a particular producer, in decision block 220.

In decision block 220, RAE unit 125 analyzes the VLIW instruction block to ensure that a producer instruction can generate a value and deliver it over the bypass at the specific time that all consumers of the value can read it. For a bypass to be utilized, RAE unit 125 must also recognize that, within the same atomic block of code, a new producer with the same specified destination follows the first producer instruction. When the instruction block is retired, the value generated by the new producer is externally visible to the system in the specified architectural register, such that all resulting register updates eliminated were internal to the block and need not be observable from outside the block.

If a bypass is not available, control passes from decision block 220 to block 225, where the instructions are dispatched from the instruction cache 130. The instructions are forwarded to the execution units 145 in block 230. Control passes to block 235, where the instructions are retired in a normal manner. The data values are placed in the specified registers and the register file is updated. Any event that may prevent the instruction block from retiring atomically as a whole (e.g. an exception) also requires the instructions to be executed and retired in a normal manner, without utilizing the bypass network, so that the data values are updated and visible in the architectural register.

If a bypass is available in decision block 220, control passes to block 240. In block 240, the instructions are dispatched from the instruction cache 130 in block retirement mode. The instruction block then proceeds to block 245 for execution in execution units 145. Control then passes to block 250. In one embodiment of the present invention, bypasses can be “named” and treated as virtual registers. Named bypass may be any bypass or a specific bypass from the output of one execution unit to the input of another one. When the relative location of both producer and consumer in the execution pipelines are determined during the pre-cache scheduling operation, the name of the bypass carrying the data replaces the destination register for the producer and the appropriate source of the consumer. These named bypasses speed data from producer to consumer by eliminating the associative match operation currently implemented in bypass networks. There is no longer a need to compare in parallel every conceivable potential venue from where the desired data might come from for multiple cycles. Due to the analysis of the pre-cache scheduling of instructions, the relative positions of the producers and consumers are known in both space and time by RAE unit 125. With the bypasses named, performance of the bypass network is enhanced, and thereby, the overall speed of the processor system is also increased.

Control is forwarded to block 255, where the all consumers can receive the data over the bypass at the same time. In this manner, any superfluous register accesses isolated within the instruction block can be eliminated. By utilizing the bypass network and eliminating the register accesses, overall processor system performance is improved.

If any exceptions are found during execution of the instruction blocks, the register access elimination cannot be performed. Typically, the register accesses are eliminated only when the instruction blocks are fully retired, and when no exceptions are found. These exceptions include, but are not limited to, interrupt handler code, illegal instructions, and consumers previously not identified by RAE unit 125 (“implicit consumers”). All the instructions in the instruction block are annulled following an exception by flushing the pipeline. The instruction block flushed from the pipeline will restart execution from instruction cache 130, now with the bypass network disabled so that all register accesses are performed and exceptions can be precise as to a specific instruction boundary.

In another embodiment of the invention, for very wide superscalar micro-architectures, where bypasses from one pipe to every other pipe are unlikely to be feasible with so many parallel pipelines, the scheduler needs to take the availability and potential of bypasses into account to maximize register access elimination. A unit may be implemented within the scheduler to determine the potential gain of utilizing a bypass. For example, with a store instruction, the unit would request that the scheduler attempt to execute the producer (i.e. a multiplier) and consumer (i.e. the store instruction) closer to optimize the bypass in order to eliminate the corresponding register accesses. However, if the store is not the sole or last consumer of the register, and another instruction many cycles later needs access to the data to be stored in the register, the motivation to create the bypass and force the producer (multiplier) and first consumer (store) together may no longer exist. In some instances, there might still exist a net gain identified by this specialized unit. While the register write may not be eliminated as a result of additional consumers downstream, the read of the register can be eliminated as a result of the bypass of the store instruction. One skilled in the art will appreciate that this unit designed to generate a bypass analysis on the overall gain to the processor system may be incorporated into RAE unit 125. Likewise, this unit can be similarly incorporated into the scheduler 120, as a unit within the scheduler or as a single-unit scheduler capable of the same analysis.

Although various embodiments are specifically illustrated and described herein, it will be appreciated that modifications and variations of the present invention are covered by the above teachings and within the purview of the appended claims without departing from the spirit and intended scope of the invention.

What is claimed is:

1. A method of processing instructions in a processing system, comprising:
pre-cache scheduling a set of instructions;
determining whether a register access for one of said instructions can be bypassed based on said pre-cache scheduling of said set of instructions;
executing said set of instructions in a block retirement mode; and
utilizing a bypass during execution of said instruction.

2. The method of claim 1 wherein said pre-cache scheduling of said set of instructions occurs in a scheduler prior to placement of said set of instructions in an instruction cache.

3. The method of claim 2 wherein determining whether a register access can be bypassed further comprises:
determining which instructions can utilize a bypass; and
determining which register access can be eliminated.

4. The method of claim 3 wherein said register access is a register read.

5. The method of claim 3 wherein said register access is a register write.

6. The method of claim 3 wherein eliminating said register access further comprises:
delivering a generated data value from said set of instructions to all other instructions requiring said data value within said instruction block; and
completing block retirement of said set of instructions.

7. The method of claim 6 wherein utilizing a bypass includes generating a named bypass for use as a virtual register, eliminating a content addressable memory match.

8. A method of processing instructions in a processing system, comprising:
pre-cache scheduling a set of instructions;
determining whether a register access for one of said instructions can be bypassed based on said pre-cache scheduling of said set of instructions;
performing a bypass potential analysis;
executing said set of instructions in a block retirement mode; and
utilizing a bypass during execution of said instruction.

9. The method of claim 8 wherein performing a bypass potential analysis includes ordering of said set of instructions during said pre-cache scheduling.

10. The method of claim 9 wherein utilizing a bypass includes generating a named bypass for use as a virtual register, eliminating a content addressable memory match.

11. A processing system comprising:
a scheduler to group a plurality of instruction sets for block retirement;
a register access elimination unit coupled to said scheduler to perform a dependency analysis on said plurality of instruction sets;
an instruction cache coupled to said register access elimination unit;
a bypass network coupled to said instruction cache; wherein said bypass network includes:
a register file; and
a plurality of pipeline registers.

12. The processing system of claim 12 wherein said dependency analysis includes determining bypass availability and register access elimination.

13. The processing system of claim 13 wherein said plurality of pipeline registers utilize a named bypass system.

14. The processing system of claim 14 wherein said named bypass system creates a plurality of virtual registers and eliminates an associative match.

15. The processing system of claim 11 wherein said scheduler performs a bypass potential analysis on said plurality of instruction sets.

16. A processing system comprising:
an external memory unit;
an instruction fetch unit coupled to said memory unit to fetch instructions from said memory unit;
a scheduler to group a plurality of instruction sets for block retirement;
a register access elimination unit coupled to said scheduler to perform a dependency analysis on said plurality of instruction sets;
an instruction cache coupled to said register access elimination unit;
a bypass network coupled to said instruction cache; wherein said bypass network includes:
a register file; and
a plurality of pipeline registers.

17. The processing system of claim 16 wherein said dependency analysis includes determining bypass availability and register access elimination.

18. The processing system of claim 17 wherein said plurality of pipeline registers utilize a named bypass system.

19. The processing system of claim 16 wherein said scheduler performs a bypass potential analysis on said plurality of instruction sets.

20. The processing system of claim 16 wherein said external memory unit and said register file are updated at writeback when a bypass cannot be utilized.

21. A set of instructions residing in a storage medium, said set of instructions capable of being executed by a processor to implement a method to process instructions, the method comprising:
pre-cache scheduling a set of instructions;
determining whether a register access for one of said instructions can be bypassed based on said pre-cache scheduling of said set of instructions;
executing said set of instructions in a block retirement mode; and
utilizing a bypass during execution of said instruction.

22. The set of instructions of claim 21 wherein said pre-cache scheduling of said set of instructions occurs in a scheduler prior to placement in an instruction cache.

23. The set of instructions of claim 22 wherein determining whether a register access can be bypassed further comprises:
determining which instructions can utilize a bypass; and
determining which register access can be eliminated.

24. The set of instructions of claim 23 wherein said register access is a register read.

25. The set of instructions of claim 23 wherein said register access is a register write.

26. The set of instructions of claim 23 wherein eliminating said register access further comprises:
delivering a generated data value from said set of instructions to all other instructions requiring said data value within said instruction block; and
completing block retirement of said set of instructions.

27. The set of instructions of claim 26 wherein utilizing a bypass includes generating a named bypass for use as a virtual register, eliminating a content addressable memory match.
